(19) United States
(12) Patent Application Publication
(10) Pub. No.: US 2024/0355512 A1
(43) Pub. Date: Oct. 24, 2024

(54) RESISTIVE PASTE, CHIP RESISTOR AND GLASS PARTICLES

(71) Applicant: Panasonic Intellectual Property Management Co., Ltd., Osaka (JP)

(72) Inventors: Yuki AOIKE, Fukui (JP); Hirokatsu ITO, Fukui (JP); Kenichi MATSUSHIMA, Hyogo (JP); Shogo NAKAYAMA, Fukui (JP); Tomohiro FUJITA, Osaka (JP); Takashi OHBAYASHI, Osaka (JP)

(21) Appl. No.: 18/684,148

(22) PCT Filed: Aug. 10, 2022
(86) PCT No.: PCT/JP2022/030572

§ 371 Date: Feb. 15, 2024

(30) Foreign Application Priority Data
Aug. 18, 2021 (JP) 2021-133636
Mar. 29, 2022 (JP) 2022-054533

(51) Int. Cl. H01C 7/06; H01C 17/00; H01C 17/065

(52) U.S. Cl. CPC H01C 7/06; H01C 17/006; H01C 17/06526; H01C 17/06546; H01C 17/06586

(57) ABSTRACT

A resistive paste according to the present disclosure includes metal particles, insulating particles, glass particles, and a metal silicide. The metal particles include copper and nickel. The insulating particles include at least one of alumina, zirconia, zinc oxide, or boron nitride. A chip resistor according to the present disclosure includes a resistive element and a substrate. The resistive element includes the resistive paste as a material and is disposed on the substrate.

### TECHNICAL FIELD

The present disclosure generally relates to resistive pastes, chip resistors, and glass particles and specifically relates to a resistive paste including metal particles, a chip resistor including a resistive element including the resistive paste as a material, and glass particles included in the resistive paste.

### BACKGROUND ART

Patent Literature 1 describes a resistive paste including an electrically conductive part formed from metal particles, an inorganic binder component formed from low-melting-point glass particles, a resistance value adjusting component formed from electrically non-conductive inorganic particles (insulating particles), and an organic vehicle. The metal particles include copper and nickel. The non-conductive inorganic particles include, for example, alumina.

The resistive paste described in Patent Literature 1 includes the resistance value adjusting component added thereto and thus increases the specific resistance of a resistive element including the resistive paste as a material, but increasing the addition amount of the resistance value adjusting component in an attempt to further increase the specific resistance may excessively reduce the temperature coefficient of resistance (hereinafter referred to as “TCR”) of the resistive element.

### CITATION LIST

### Patent Literature

Patent Literature 1: JP 2015-46567 A

### SUMMARY OF INVENTION

It is an object of the present disclosure to provide a resistive paste, a chip resistor, and glass particles which are configured to achieve both high specific resistance and low TCR of a resistive element.

A resistive paste according to an aspect of the present disclosure includes metal particles, insulating particles, glass particles, and a metal silicide. The metal particles include copper and nickel. The insulating particles include at least one of alumina, zirconia, zinc oxide, or boron nitride.

A resistive paste according to another aspect of the present disclosure includes metal particles, insulating particles, a metal silicide, and glass particles. The metal particles include copper and nickel. The insulating particles include at least one of alumina, zirconia, zinc oxide, or boron nitride. The glass particles include at least boric oxide and aluminum oxide. A nickel compound including nickel silicide is produced from the resistive paste when a resistive element of a chip resistor is formed from the resistive paste.

A chip resistor according to an aspect of the present disclosure includes a resistive element and a substrate. The resistive element includes the resistive paste as a material and is disposed on the substrate.

Glass particles according to an aspect of the present disclosure are to be included in the resistive paste.

### BRIEF DESCRIPTION OF DRAWINGS

FIG. 1 is a sectional view of a chip resistor including a resistive element including a resistive paste according to a first embodiment and a second embodiment as a material; and

FIG. 2 is a graph of a relationship between TCR and the proportion of glass particles B to the total of glass particles A and B included in the resistive paste according to the second embodiment.

### DESCRIPTION OF EMBODIMENTS

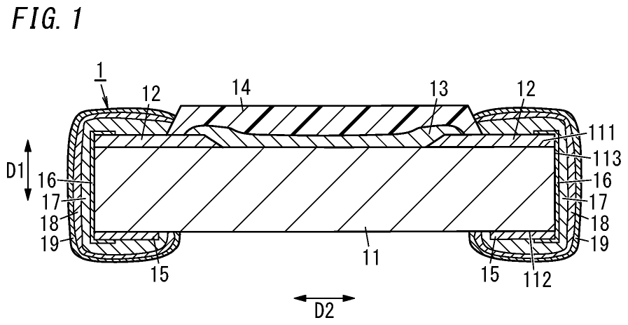

A resistive paste, a chip resistor, and glass particles according to a first embodiment and a second embodiment will be described below with reference to the drawings. FIG. 1 to be referred to in the following description of the first and second embodiments is a schematic representation. That is to say, the ratio of the dimensions (including thicknesses) of respective constituent elements illustrated on the drawing does not always reflect their actual dimensional ratio.

### First Embodiment

### (1) Configuration of Resistive Paste

First of all, a configuration of a resistive paste according to a first embodiment will be described.

The resistive paste according to the first embodiment is a material for a resistive element 13 (see FIG. 1) of a chip resistor 1 which will be described later, and the resistive paste is employed to form the resistive element 13.

The resistive paste according to the first embodiment includes metal particles, insulating particles, glass particles, an organic vehicle, and a metal silicide.

The metal particles include copper (Cu) and nickel (Ni). More specifically, the metal particles are a combination of copper particles and nickel particles. Note that the metal particles are not limited to the combination of the copper particles and the nickel particles but may be alloy particles of copper and nickel. Moreover, the metal particles may be a combination of copper particles and alloy particles, a combination of nickel particles and alloy particles, or a combination of copper particles, nickel particles, and alloy particles. The metal particles form an electrically conductive pathway in the resistive element 13 (see FIG. 1) after baking. The metal particles include at least copper and nickel and may further include other metals.

The insulating particles include at least one of alumina (Al₂O₃), zirconia (ZrO₂), zinc oxide (ZnO), or boron nitride (BN). In the resistive paste according to the first embodiment, the insulating particles include alumina. The insulating particles suppress the glass particles which will be described later from melting and flowing to suppress the electrically conductive pathway from breaking while the insulating particles reduce the content of the metal particles in the resistive element 13 (see FIG. 1) after baking to increase the resistance value.

The glass particles include, for example, silicium oxide (e.g., SiO₂). The glass particles may include other oxides in addition to the silicium oxide. Examples of the other oxides include boric oxide (B₂O₃). While the glass particles improve adhesiveness by increasing wettability to a substrate 11 (see FIG. 1) which will be described later, the glass particles melt and solidify in the entirety of the resistive element 13, thereby toughening the resistive element 13. Moreover, the glass particles are an insulator and thus further have a function of adjusting the resistance value.

The organic vehicle includes, for example, at least one of an organic binder or an organic solvent. In the resistive paste according to the first embodiment, the organic vehicle includes both the organic binder and the organic solvent. The organic binder is, for example, a cellulose-based resin or an acryl-based resin. The organic solvent is, for example, terpineol or butyl carbitol acetate. The mass percentage of the organic vehicle is preferably, for example, 5 to 200, more preferably 10 to 150, and much more preferably 20 to 100 with the metal particles set as 100.

The resistive paste includes, as the metal silicide, at least one of titanium silicide (TiSi₂), zirconium silicide (ZrSi₂), hafnium silicide (HfSi₂), niobium silicide (NbSi₂), tantalum silicide (TaSi₂), chromium silicide (CrSi₂), tungsten silicide (WSi₂), molybdenum silicide (MoSi₂), iron silicide (FeSi₂), magnesium silicide (Mg₂Si), sodium silicide (Na₂Si), or platinum silicide (PtSi). The resistive paste according to the first embodiment includes titanium silicide as the metal silicide.

In the resistive paste according to the first embodiment, baking causes a reaction between the metal silicide and the metal particles (copper and nickel), and in response to the reaction, the composition of the copper and the nickel in the metal particles changes, and nickel silicide (Ni₃₁Si₁₂) is produced. As a result, the TCR of the resistive element 13 (see FIG. 1) formed by baking can be increased. That is, it becomes possible to suppress the TCR from decreasing along with an increase in the addition amount of the insulating particles.

### (2) Configuration of Chip Resistor

Next, the chip resistor 1 according to the first embodiment will be described with reference to FIG. 1.

As shown in FIG. 1, the chip resistor 1 according to the first embodiment includes the substrate 11, a plurality of (in the example shown in the figure, two) upper electrodes 12, the resistive element 13, a protection film 14, a plurality of (in the example shown in the figure, two) lower electrodes 15, and a plurality of (in the example shown in the figure, two) end-face electrodes 16. Further, the chip resistor 1 according to the first embodiment further includes a plurality of (in the example shown in the figure, two) first plating layers 17, a plurality of (in the example shown in the figure, two) second plating layers 18, and a plurality of (in the example shown in the figure, two) third plating layers 19. That is, the chip resistor 1 according to the first embodiment includes the substrate 11 and the resistive element 13.

### (2.1) Substrate

The substrate 11 is, for example, a ceramic substrate. A material for the ceramic substrate is, for example, an alumina sintered body having an alumina content percentage of greater than or equal to 96%. The substrate 11 has a rectangular shape in plan view in a first direction D1. As shown in FIG. 1, the substrate 11 has a first principal surface (upper surface) 111, a second principal surface (lower surface) 112, and an outer peripheral surface 113. The first principal surface 111 and the second principal surface 112 face each other in the first direction D1. Each of the first principal surface 111 and the second principal surface 112 is a flat surface along a second direction D2 orthogonal to the first direction DI. Moreover, the outer peripheral surface 113 includes four side surfaces along the first direction D1. The first direction D1 is a direction (up/down direction in FIG. 1) parallel to a thickness direction defined with respect to the substrate 11. The second direction D2 is a direction (left/right direction in FIG. 1) parallel to a longitudinal direction or a width direction (short direction) of the substrate 11.

### (2.2) Upper Electrode

The plurality of upper electrodes 12 are disposed on the first principal surface 111 of the substrate 11. In the example shown in FIG. 1, the plurality of upper electrodes 12 are disposed at both ends in the second direction D2 on the first principal surface 111 of the substrate 11. Examples of a material for the plurality of upper electrodes 12 include a copper (Cu)-based alloy. The plurality of upper electrodes 12 are formed by, for example, printing a thick film material and baking the thick film material.

### (2.3) Resistive Element

The resistive element 13 is disposed on the first principal surface 111 of the substrate 11. In the example shown in FIG. 1, the resistive element 13 is disposed at a center part on the first principal surface 111 of the substrate 11. Examples of a material for the resistive element 13 include the resistive paste described above. Both ends of the resistive element 13 in the second direction D2 are in contact with the plurality of upper electrodes 12 and are electrically connected to the plurality of upper electrodes 12. The resistive element 13 has, for example, a rectangular shape in plan view in the first direction D1 but may have any shape in accordance with the resistance value of the resistive element 13.

### (2.4) Protection Film

The protection film 14 is a film for protecting the resistive element 13. The protection film 14 covers at least part of the resistive element 13. In the example shown in FIG. 1, the protection film 14 covers the entire region (entirety) of the resistive element 13. Examples of a material for the protection film 14 include an epoxy resin. The protection film 14 has, for example, a rectangular shape in plan view in the first direction D1 but may have any shape that matches the shape of the resistive element 13. The material for the protection film 14 is not limited to the epoxy resin but may be, for example, a polyimide resin.

### (2.5) Lower Electrode

The plurality of lower electrodes (back surface electrodes) 15 are disposed on the second principal surface 112 of the substrate 11. In the example shown in FIG. 1, the plurality of lower electrodes 15 are disposed at both ends in the second direction D2 on the second principal surface 112 of the substrate 11. The plurality of lower electrodes 15 correspond to the plurality of upper electrodes 12 on a one-to-one basis. Examples of a material for the plurality of lower electrodes 15 include a Cu-based alloy. The plurality of lower electrodes 15 are formed by, for example, printing a thick film material and baking the thick film material.

### (2.6) End-Face Electrode

The plurality of end-face electrodes 16 are disposed to cover the outer peripheral surface 113 of the substrate 11. In the example shown in FIG. 1, the plurality of end-face electrodes 16 are disposed to cover both side surfaces in the second direction D2 of the four side surfaces included in the outer peripheral surface 113 of the substrate 11. The plurality of end-face electrodes 16 correspond to the plurality of upper electrodes 12 on a one-to-one basis and correspond to the plurality of lower electrodes 15 on a one-to-one basis. Examples of a material for the plurality of end-face electrodes 16 include a mixture of carbon powder, silver (Ag), and an epoxy resin. In the first direction D1, each of the plurality of end-face electrodes 16 has a first end (upper end) in contact with a corresponding upper electrode 12 of the plurality of upper electrodes 12 and a second end (lower end) in contact with a corresponding lower electrode 15 of the plurality of lower electrodes 15. Thus, the plurality of upper electrodes 12 and the plurality of lower electrodes 15 are electrically connected via the plurality of end-face electrodes 16.

### (2.7) First Plating Layer

The plurality of first plating layers 17 include, for example, copper (Cu) plating. In the example shown in FIG. 1, the plurality of first plating layers 17 cover the plurality of upper electrodes 12, the plurality of lower electrodes 15, and the plurality of end-face electrodes 16 at both ends of the substrate 11 in the second direction D2. Moreover, the plurality of first plating layers 17 are in contact with a surface of the protection film 14. In the chip resistor 1 according to the first embodiment, disposing the first plating layers 17 enables the resistance value of the chip resistor 1 to be adjusted. Note that the first plating layers 17 may be omitted.

### (2.8) Second Plating Layer

The plurality of second plating layers 18 include, for example, nickel (Ni) plating. In the example shown in FIG. 1, the plurality of second plating layers 18 cover the plurality of first plating layers 17 at both the ends of the substrate 11 in the second direction D2. Moreover, the plurality of second plating layers 18 are in contact with the protection film 14.

### (2.9) Third Plating Layer

The plurality of third plating layers 19 include, for example, tin (Sn) plating. In the example shown in FIG. 1, the plurality of third plating layers 19 cover the plurality of second plating layers 18 at both the ends of the substrate 11 in the second direction D2. Moreover, the plurality of third plating layers 19 are in contact with the surface of the protection film 14.

### (3) Method for Manufacturing Chip Resistor

Next, a method for manufacturing the chip resistor 1 according to the first embodiment will be described.

The method for manufacturing the chip resistor 1 according to the first embodiment includes first to ninth steps.

The first step includes preparing the substrate 11. More specifically, in the first step, a substrate body as a base of the substrate 11 of each of a plurality of chip resistors 1 is prepared. The substrate body is, for example, a ceramic substrate. A material for the ceramic substrate, which is the substrate body, is, for example, an alumina sintered body having an alumina content percentage of greater than or equal to 96%.

The second step includes forming the plurality of lower electrodes 15 of each of the plurality of chip resistors 1 on the second principal surface of the substrate body. More specifically, in the second step, for example, a thick film material is printed and is then baked to form a Cu-based alloy film on the second principal surface of the substrate body, thereby forming the plurality of lower electrodes 15 of each of the plurality of chip resistors 1. The second principal surface of the substrate body is a surface which will be the second principal surface 112 of the substrate 11 of each of the plurality of chip resistors 1.

The third step includes forming the plurality of upper electrodes 12 on the first principal surface of the substrate body. The first principal surface of the substrate body is a surface which will be the first principal surface 111 of the substrate 11 of each of the plurality of chip resistors 1. More specifically, in the third step, for example, a thick film material is printed and is then baked to form a Cu-based alloy film on the first principal surface of the substrate body, thereby forming the plurality of upper electrodes 12 of each of the plurality of chip resistors 1.

The fourth step includes forming the resistive element 13 of each of the plurality of chip resistors 1. More specifically, in the fourth step, the resistive paste is printed on the first principal surface of the substrate body and is then baked to form the resistive element 13. At this time, in the resistive element 13, the metal silicide (titanium silicide) and the metal particles (copper and nickel) react with each other, thereby producing a metal silicide (nickel silicide) different from the metal silicide (titanium silicide). That is, in the chip resistor 1 according to the first embodiment, the resistive element 13 includes nickel silicide.

The fifth step includes forming the protection film 14 of each of the plurality of chip resistors 1. More specifically, in the fifth step, an epoxy resin is applied to cover the entirety of the resistive element 13, and the epoxy resin is then thermally cured, thereby forming the protection film 14. As shown in FIG. 1, the protection film 14 covers contact parts where the plurality of upper electrodes 12 are in contact with the resistive element 13.

The sixth step includes dividing the plurality of chip resistors, which are formed as one piece by the first to fifth steps, except for the end-face electrodes 16, the first plating layers 17, the second plating layers 18, and the third plating layers 19 into a plurality of lath-shaped chip resistors except for the end-face electrodes 16, the first plating layers 17, the second plating layers 18, and the third plating layers 19. More specifically, in the sixth step, for example, stress is applied to the plurality of chip resistors, which are formed as one piece, from upper and lower rollers (not shown), thereby dividing the plurality of chip resistors into the plurality of lath-shaped chip resistors.

The seventh step includes forming the plurality of end-face electrodes 16 for each of the plurality of lath-shaped chip resistors. More specifically, in the seventh step, for example, an end-face electrode paste (not shown) made of the mixture is disposed on rollers (not shown) made of stainless steel, and the rollers are then rotated, thereby forming the plurality of end-face electrodes 16 for each of the plurality of lath-shaped chip resistors. Thus, for each of the plurality of lath-shaped chip resistors, the plurality of upper electrodes 12 and the plurality of lower electrodes 15 are electrically connected via the plurality of end-face electrodes 16.

The eighth step includes rotating the rollers to divide the plurality of lath-shaped chip resistors into separated pieces of chip resistors.

The ninth step includes forming the first plating layers 17 to the third plating layers 19 for each of the plurality of chip resistors. More specifically, in the ninth step, for each of the plurality of chip resistors, three plating layers, namely, the first plating layers 17, the second plating layers 18, and the third plating layers 19 are formed in this order.

By the first to ninth steps described above, the chip resistor 1 according to the first embodiment can be manufactured.

### (4) Characteristics of Chip Resistor

Next, the characteristics of the chip resistor 1 including the resistive paste according to the first embodiment will be described with reference to a comparative example. The volume resistivity of the chip resistor 1 is preferably, for example, greater than or equal to 200 μΩ·cm. Moreover, the TCR of the chip resistor 1 is preferably, for example, greater than or equal to −50 ppm/° C. and less than or equal to +50 ppm/° C.

First of all, a resistive paste in Comparative Example 1 includes metal particles, glass particles, an organic vehicle, and insulating particles. The metal particles include copper and nickel. The ratio of the copper to the nickel in the metal particles is 6:4. Moreover, the insulating particles include alumina. In Comparative Example 1, as the proportion of the insulating particle (alumina) in the resistive paste increases, the resistance value of the resistive element including the resistive paste as a material increases, but the TCR of the resistive element excessively decreases.

Moreover, a resistive paste in Comparative Example 2 includes metal particles, glass particles, an organic vehicle, and a metal silicide. The metal particles include copper and nickel. The ratio of the copper to the nickel in the metal particles is 55:45. Moreover, the metal silicide is titanium silicide. In Comparative Example 2, as the proportion of the metal silicide (titanium silicide) in the resistive paste increases, the resistance value of the resistive element including the resistive paste as a material increases, and the TCR of the resistive element also increases.

In contrast, in the first embodiment, the resistive paste includes metal particles, glass particles, insulating particles, an organic vehicle, and a metal silicide. The metal particles include copper and nickel. The ratio of the copper to the nickel in the metal particles is 55:45. Moreover, the insulating particles include alumina, and the metal silicide includes titanium silicide.

In an example, when in the resistive paste, the proportion of the metal particles is 70 wt %, the proportion of the glass particles is 7 wt %, the proportion of the insulating particles (alumina) is 20 wt %, and the proportion of the metal silicide (titanium silicide) is 3 wt %, the resistance value of the resistive element 13 including the resistive paste as a material is 364 mΩ, and the TCR of the resistive element 13 is −19 ppm. Here, the volume of the resistive element 13 is 5.44×10⁻² mm³ (length 1.6 mm×width 1.7 mm×thickness 20 μm), and therefore, the volume resistivity of the resistive element 13 including the resistive paste according to the first embodiment as a material satisfies the reference described above. Moreover, in the resistive element 13 including the resistive paste according to the first embodiment as a material, the TCR when the temperature changes from 25° C. to 125° C. is −19 ppm, and therefore, the reference described above for the TCR is satisfied. In sum, when the resistive element 13 is formed from the resistive paste according to the first embodiment, the TCR of the resistive element 13 can be reduced while the resistance value of the resistive element 13 is increased. That is, the resistive paste according to the first embodiment enables both the high specific resistance and the low TCR of the resistive element 13 to be achieved.

### (5) Effect

The resistive paste according to the first embodiment includes the insulating particles as described above. Therefore, when the resistive element 13 of the chip resistor 1 is formed from the resistive paste according to the first embodiment, the specific resistance of the resistive element 13 can be increased. Moreover, the resistive paste according to the first embodiment further includes the metal silicide (e.g., titanium silicide) as described above. Thus, when the resistive element 13 of the chip resistor 1 is formed from the resistive paste according to the first embodiment, the TCR of the resistive element 13 can be suppressed from excessively decreasing due to an increase in the addition amount of the insulating particles. That is, the resistive paste according to the first embodiment enables both the high specific resistance and the low TCR of the resistive element 13 to be achieved.

### (6) Variations

The first embodiment is a mere example of various embodiments of the present disclosure. Various modifications may be made to the first embodiment depending on design and the like as long as the object of the present disclosure is achieved. Variations of the first embodiment will be described below. Any of the variations to be described below may be combined as appropriate.

In the first embodiment, the resistive paste includes titanium silicide as the metal silicide, but the resistive paste may include a metal silicide other than the titanium silicide. The resistive paste may include, as the metal silicide, for example, zirconium silicide, hafnium silicide, niobium silicide, tantalum silicide, chromium silicide, tungsten silicide, molybdenum silicide, iron silicide, magnesium silicide, sodium silicide, or platinum silicide. Moreover, the resistive paste may include, as the metal silicide, two or more of the materials described above. In sum, the resistive paste at least includes, as the metal silicide, at least one of titanium silicide, zirconium silicide, hafnium silicide, niobium silicide, tantalum silicide, chromium silicide, tungsten silicide, molybdenum silicide, iron silicide, magnesium silicide, sodium silicide, or platinum silicide.

In the first embodiment, the resistive paste includes alumina as the insulating particles, but the resistive paste may include insulating particles other than the alumina. The resistive paste may include, as the insulating particles, zirconia, zinc oxide, or boron nitride. Moreover, the resistive paste may include, as the insulating particles, two or more of the materials described above. In sum, the resistive paste at least includes, as the insulating particles, at least one of alumina, zirconia, zinc oxide, or boron nitride.

In the first embodiment, each end-face electrode 16 has a U-shape when viewed in a direction orthogonal to both the first direction D1 and the second direction D2 (a direction vertical to the paper surface of FIG. 1). However, the shape of each end-face electrode 16 is not limited to the U-shape but may be an I-shape along the first direction D1 for example. In this case, the first end (upper end) of each end-face electrode 16 in the first direction D1 is in contact with a side surface of a corresponding one of the upper electrodes 12, and the second end (lower end) of each end-face electrode 16 in the first direction D1 is in contact with a side surface of a corresponding one of the lower electrodes 15. Thus, the plurality of upper electrodes 12 and the plurality of lower electrodes 15 can be electrically connected via the plurality of end-face electrodes 16.

### Second Embodiment

A resistive paste, a chip resistor 1, and glass particles according to a second embodiment will be described. Regarding the chip resistor 1 according to the second embodiment, components similar to those of the chip resistor 1 according to the first embodiment are denoted by the same reference signs, and the descriptions thereof may be omitted.

The resistive paste according to the second embodiment is different from the resistive paste according to the first embodiment in that the composition of the glass particles is different from that in the first embodiment.

### (1) Configuration of Resistive Paste

The resistive paste according to the second embodiment includes metal particles (a metal electrical conductor), insulating particles (an insulator), a metal silicide, and glass particles (glass). That is, the glass particles are included in the resistive paste. Moreover, the resistive paste according to the second embodiment further includes an organic vehicle.

The metal particles include copper and nickel. In the second embodiment, the metal particles include, for example, a copper-nickel alloy. The metal particles form an electrically conductive pathway in a resistive element 13 (see FIG. 1) after baking. The metal particles include at least copper and nickel and may further include other metals.

The insulating particles include at least one of alumina, zirconia, zinc oxide, or boron nitride. In the second embodiment, the insulating particles include, for example, alumina. The insulating particles suppress the glass particles which will be described later from melting and flowing to suppress the electrically conductive pathway from breaking while the insulating particles reduce the content of the metal particles in the resistive element 13 (see FIG. 1) after baking to increase the resistance value.

The metal silicide includes, for example, titanium silicide.

The glass particles include boric oxide (B₂O₃) as a main component, include silicium oxide (SiO₂), aluminum oxide (Al₂O₃), and tantalum oxide (Ta₂O₅) as sub-components, and include at least one of magnesium oxide (MgO), calcium oxide (CaO), or barium oxide (BaO). In the second embodiment, the glass particles include all of magnesium oxide, calcium oxide, and barium oxide.

The glass particles react with copper, nickel, and metal silicide (titanium silicide) in a baking step of the resistive paste, thereby producing nickel silicide (Ni₃₁Si₁₂) and nickel aluminum boride (Ni₂₀Al₃B₆) which will be described later. These nickel silicide and nickel aluminum boride have a function of adjusting a temperature coefficient of resistance (TCR) of the resistive element 13 which will be described later. In the second embodiment, glass particles B which will be described later correspond to the glass particles described above.

Moreover, to melt and solidify the entirety of the resistive element 13 to toughen the resistive element 13 while improving adhesiveness between a substrate 11 which will be described later and the resistive element 13, the resistive paste may further contain glass particles, such as glass particles A which will be described later, including plumbic oxide (PbO) as a main component. Note that so as not to suppress the production of the nickel silicide and the nickel aluminum boride, the proportion of the plumbic oxide included in the glass particles (glass particles A) alone is preferably set to 80 wt % or less, and the proportion of the total of the plumbic oxide included in the glass particles A and the plumbic oxide included in the glass particles B in the total of the glass particles A and B is preferably set to 45 wt % or less. For example, the glass particles A include plumbic oxide as a main component, and boric oxide, silicium oxide, and zinc oxide as sub-components. Moreover, the glass particles are an insulator and thus further have a function of adjusting the resistance value.

In the resistive paste according to the second embodiment, the glass particles (glass particles B) include at least boric oxide and aluminum oxide as described above. Moreover, in the resistive paste according to the second embodiment, the glass particles (glass particles B) further include silicium oxide, tantalum oxide, magnesium oxide, calcium oxide, and barium oxide.

The organic vehicle includes, for example, at least one of an organic binder or an organic solvent. In the resistive paste according to the second embodiment, the organic vehicle includes both the organic binder and the organic solvent. The organic binder is, for example, a cellulose-based resin or an acryl-based resin. The organic solvent is, for example, terpineol or butyl carbitol acetate. The mass percentage of the organic vehicle is preferably, for example, 5 to 200, more preferably 10 to 150, and much more preferably 20 to 100 with the metal particles set as 100.

### (2) Configuration of Chip Resistor

Next, the chip resistor 1 according to the second embodiment will be described with reference to FIG. 1.

As shown in FIG. 1, the chip resistor 1 according to the second embodiment includes the substrate 11, a plurality of (in the example shown in the figure, two) upper electrodes 12, the resistive element 13, a protection film 14, a plurality of (in the example shown in the figure, two) lower electrodes 15, and a plurality of (in the example shown in the figure, two) end-face electrodes 16. Further, the chip resistor 1 according to the second embodiment further includes a plurality of (in the example shown in the figure, two) first plating layers 17, a plurality of (in the example shown in the figure, two) second plating layers 18, and a plurality of (in the example shown in the figure, two) third plating layers 18. In sum, the chip resistor 1 according to the second embodiment includes: the substrate 11: and the resistive element 13 including the resistive paste described above as a material and disposed on the substrate 11.

The resistive element 13 includes a nickel compound. The nickel compound includes, for example, nickel silicide. The nickel silicide is, for example, nickel silicide (Ni₃₁Si₁₂). The nickel compound further includes nickel aluminum boride. The nickel aluminum boride is, for example, nickel aluminum boride (Ni₂₀Al₃B₆). In other words, when the resistive element 13 of the chip resistor 1 is formed from the resistive paste described above, a nickel compound including nickel silicide is produced.

### (3) Method for Manufacturing Chip Resistor

Next, a method for manufacturing the chip resistor 1 according to the second embodiment will be described.

The method for manufacturing the chip resistor 1 according to the second embodiment includes first to eighth steps.

The first step includes preparing the substrate 11. More specifically, in the first step, a substrate body as a base of the substrate 11 of each of a plurality of chip resistors 1 is prepared. The substrate body is, for example, a ceramic substrate. A material for the ceramic substrate, which is the substrate body, is, for example, an alumina sintered body having an alumina content percentage of greater than or equal to 96%.

The second step includes forming the plurality of upper electrodes 12 on a first principal surface of the substrate body. The first principal surface of the substrate body is a surface which will be a first principal surface 111 of the substrate 11 of each of the plurality of chip resistors 1. More specifically, in the second step, for example, a thick film material is printed and is then baked to form a Cu-based alloy film on the first principal surface of the substrate body, thereby forming the plurality of upper electrodes 12 of each of the plurality of chip resistors 1.

The third step includes forming the resistive element 13 of each of the plurality of chip resistors 1. More specifically, in the third step, the resistive paste is printed on the first principal surface of the substrate body and is then baked to form the resistive element 13. At this time, in the resistive element 13, the metal silicide (titanium silicide) and the metal particles (copper and nickel) react with each other via the glass particles, thereby producing a metal silicide, specifically, nickel silicide (Ni₃₁Si₁₂), different from the metal silicide (titanium silicide). Further, at this time, titanium of the titanium silicide included in the resistive paste is taken in the glass particles, and the silicon in the titanium silicide reacts with the metal particles (copper and nickel), and thereby, almost all of the titanium silicide included in the resistive paste disappears. Moreover, the metal particles (copper and nickel) directly react with the glass particles, thereby further producing a metal boride, specifically, nickel aluminum boride (Ni₂₀Al₃B₆). Thus, in the chip resistor 1 according to the second embodiment, the resistive element 13 includes at least nickel silicide (silicidized nickel).

The fourth step includes forming the protection film 14 of each of the plurality of chip resistors 1. More specifically, in the fourth step, an epoxy resin is applied to cover the entirety of the resistive element 13, and the epoxy resin is then thermally cured, thereby forming the protection film 14. As shown in FIG. 1, the protection film 14 covers contact parts where the plurality of upper electrodes 12 are in contact with the resistive element 13.

The fifth step includes forming the plurality of lower electrodes 15 of each of the plurality of chip resistors 1 on a second principal surface of the substrate body. More specifically, in the second step, for example, a thick film material is printed and is then baked to form a Cu-based alloy film on the second principal surface of the substrate body, thereby forming the plurality of lower electrodes 15 of each of the plurality of chip resistors 1. The second principal surface of the substrate body is a surface which will be a second principal surface 112 of the substrate 11 of each of the plurality of chip resistors 1.

The sixth step includes cutting the plurality of chip resistors 1, which are formed as one piece by the first to fifth steps, into separated pieces of chip resistors 1. More specifically, in the sixth step, the plurality of chip resistors 1, which are formed as one piece, into separated pieces of chip resistors 1, for example, with a laser or by dicing.

The seventh step includes forming the plurality of end-face electrodes 16 for each of the separated pieces of chip resistors 1. More specifically, in the seventh step, for example, an end-face electrode paste (not shown) made of the mixture is disposed on rollers (not shown) made of stainless steel, and the rollers are then rotated, thereby forming the plurality of end-face electrodes 16 for each of the plurality of chip resistors 1. Thus, for each of the plurality of chip resistors 1, the plurality of upper electrodes 12 and the plurality of lower electrodes 15 are electrically connected via the plurality of end-face electrodes 16.

The eighth step includes forming the first plating layers 17 to the third plating layers 19 for each of the plurality of chip resistors. More specifically, in the eighth step, for each of the plurality of chip resistors 1, three plating layers, namely, the first plating layers 17, the second plating layers 18, and the third plating layers 19 are formed in this order.

By the first to eighth steps described above, the chip resistor 1 according to the second embodiment can be manufactured.

Note that in the above-described method for manufacturing the chip resistor 1, the fifth step may be executed before, for example, the second step.

### (4) Characteristics of Chip Resistor

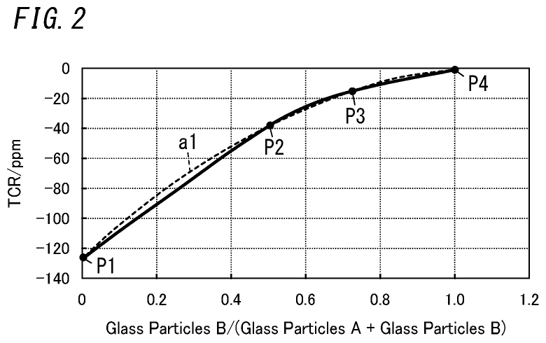

Next, the characteristics of the chip resistor 1 including the resistive paste described above will be described with reference to FIG. 2 and Tables 1 to 3. The abscissa axis of FIG. 2 shows the proportion of the glass particles B to the sum of the glass particles A and B, and the ordinate axis of FIG. 2 shows the TCR of the resistive element 13. Table 1 shows the compositional ratio of the glass particles A. Table 2 shows the compositional ratio of the glass particles B. Table 3 shows the relationship among the compound composition of the resistive paste, the electrical characteristics of a chip resistor including the resistive paste, and the reference intensity ratio (RIR) of the resistive element.

TABLE 1

| Component | Proportion (wt %) |
|---|---|
| PbO | 60~80 |
| B₂O₃ | 15~20 |
| ZnO | 1~5 |
| SiO₂ | 5~15 |

TABLE 2

| Component | Proportion(wt %) |
|---|---|
| SiO₂ | 2~7 |
| Al₂O₃ | 4~9 |
| B₂O₃ | 41~50 |
| CaO | 1~5 |
| MgO | 1~5 |
| BaO | 30~35 |
| Ta₂O₅ | 3~10 |

TABLE 3

| | | Comparative | | | |
|---|---|---|---|---|---|
| | | Example 1 | Example 1 | Example 2 | Example 3 |
| Composition | CuNi (55:45) | 69.84 | 69.84 | 69.84 | 69.84 |
| | TiSi₂ | 2.40 | 2.40 | 2.40 | 2.40 |
| | Al₂O₃ | 20.00 | 20.00 | 20.00 | 20.00 |
| | Glass Particles A | 7.76 | 3.88 | 2.16 | 0 |
| | Glass Particles B | 0 | 3.88 | 5.60 | 7.76 |
| Electrical | R_Ave (mΩ) | 300 | 350 | 414 | 363 |
| Characteristics | TCR (ppm) | −126.8 | −38.0 | −15.1 | −0.5 |
| Reference | CuNi | 45 | 47 | 46 | 40 |
| Intensity | TiSi₂ | 0.7 | 0 | 0 | 0 |
| Ratio | Al₂O₃ | 53 | 51 | 53 | 56 |
| | Ni₃₁Si₁₂ | 0.8 | 2.1 | 1.7 | 2.0 |
| | Ni₂₀Al₃B₆ | 0 | 0 | 0 | 2.1 |

(Unit: wt %)

As shown in Table 1, the glass particles A include plumbic oxide (PbO), boric oxide (B₂O₃), zinc oxide (ZnO), and silicium oxide (SiO₂). In the glass particles A, the proportion of the plumbic oxide is greater than or equal to 60 wt % and less than or equal to 80 wt %, the proportion of the boric oxide is greater than or equal to 15 wt % and less than or equal to 20 wt %, the proportion of the zinc oxide is greater than or equal to 1 wt % and less than or equal to 5 wt %, and the proportion of the silicium oxide is greater than or equal to 5 wt % and less than or equal to 15 wt %. In the second embodiment, for example, the proportion of the plumbic oxide is 71 wt %, the proportion of the boric oxide is 16 wt %, the proportion of the zinc oxide is 5 wt %, and the proportion of the silicium oxide is 8 wt %.

As shown in Table 2, the glass particles B include silicium oxide, aluminum oxide, boric oxide, calcium oxide (CaO), magnesium oxide (MgO), barium oxide (BaO), and tantalum oxide (Ta₂O₅). In the glass particles B, the proportion of the silicium oxide is greater than or equal to 2 wt % and less than or equal to 7 wt %, the proportion of the aluminum oxide is greater than or equal to 4 wt % and less than or equal to 9 wt %, and the proportion of the boric oxide is greater than or equal to 41 wt % and less than or equal to 50 wt %. Moreover, in the glass particles B, the proportion of the calcium oxide is greater than or equal to 1 wt % and less than or equal to 5 wt %, the proportion of the magnesium oxide is greater than or equal to 1 wt % and less than or equal to 5 wt %, the proportion of the barium oxide is greater than or equal to 30 wt % and less than or equal to 35 wt %, and the proportion of the tantalum oxide is greater than or equal to 3 wt % and less than or equal to 10 wt %. In the second embodiment, for example, the proportion of the silicium oxide is 4 wt %, the proportion of the aluminum oxide is 6 wt %, the proportion of the boric oxide is 46 wt %, and the proportion of the calcium oxide is 3 wt %. Moreover, the proportion of the magnesium oxide is 3 wt %, the proportion of the barium oxide is 33 wt %, and the proportion of the tantalum oxide is 5 wt %.

As shown in Table 3, a resistive paste in Comparative Example 1 includes a copper-nickel alloy (CuNi), titanium silicide (TiSi₂), aluminum oxide, and glass particles A. In Comparative Example 1, the copper-nickel alloy and the titanium silicide react with each other via the glass particles A, thereby producing nickel silicide (Ni₃₁Si₁₂). Moreover, in Comparative Example 1, the copper nickel alloy, the titanium silicide, and the aluminum oxide are also included in the resistive element 13 in addition to the nickel silicide. That is, in Comparative Example 1, as shown in Table 3, the nickel silicide, the copper-nickel alloy, the titanium silicide, and the aluminum oxide are included in the resistive element 13. In Comparative Example 1, the TCR is −126.8 ppm due to the nickel silicide and is less than −50 ppm (see point P1 in FIG. 2). Moreover, in Comparative Example 1, the average resistance value of the chip resistor is 300 mΩ. That is, in Comparative Example 1, the TCR is less than −50 ppm and is not included in the range of from greater than or equal to −50 ppm and less than or equal to +50 ppm (hereinafter referred to as a “predetermined range”).

As shown in Table 3, a resistive paste in Example 1 includes a copper-nickel alloy (metal particles), titanium silicide (a metal silicide), aluminum oxide (insulating particles), glass particles A, and glass particles B (glass particles). That is, in Example 1, the resistive paste further include the glass particles B. In Comparative Example 1, the proportion of the glass particles A in the resistive paste is 7.76 wt %, whereas in Example 1, the proportion of the glass particles A in the resistive paste is 3.88 wt %, and the proportion of the glass particles B in the resistive paste is 3.88 wt %. In Example 1, the resistive paste includes the glass particles B including, as a main component, boric oxide which is highly reactive, and therefore, the reaction of the titanium silicide is promoted, and the production amount of the nickel silicide (Ni₃₁Si₁₂) increases. Thus, in Example 1, the TCR of the resistive element 13 is −38.0 ppm and is included within the predetermined range (see point P2 in FIG. 2). Note that in Example 1, the average resistance value of the chip resistor 1 is 350 mΩ as shown in Table 3. Moreover, in Example 1, as shown in Table 3, the copper-nickel alloy, the aluminum oxide, and the nickel silicide are included in the resistive element 13.

As shown in Table 3, a resistive paste in Example 2 includes a copper-nickel alloy (metal particles), titanium silicide (a metal silicide), aluminum oxide (insulating particles), glass particles A, and glass particles B (glass particles). In Example 2, the proportion of each of the glass particle A and the glass particles B in the resistive paste is changed from those in Example 1. Specifically, in Example 2, the proportion of the glass particles A in the resistive paste is 2.16 wt %, and the proportion of the glass particles B in the resistive paste is 5.60 wt %. Thus, in Example 2, the TCR of the resistive element 13 is −15.1 ppm and is thus included within the predetermined range (see point P3 in FIG. 2). Note that in Example 2, the average resistance value of the chip resistor 1 is 414 mΩ as shown in Table 3. Moreover, in Example 2, as shown in Table 3, the copper-nickel alloy, the aluminum oxide, and the nickel silicide are included in the resistive element 13.

As shown in Table 3, a resistive paste in Example 3 includes a copper-nickel alloy (metal particles), titanium silicide (a metal silicide), aluminum oxide (insulating particles), and glass particles B (glass particles). That is, in Example 3, all of the glass particles A are replaced with the glass particles B. In Example 3, the proportion of the glass particles B in the resistive paste is 7.76 wt %. In Example 3, all of the glass particles A are replaced with the glass particles B, and thereby, the reaction between the copper-nickel alloy and the glass particles B is also activated, and therefore, nickel aluminum boride (Ni₂₀Al₃B₆) is produced in addition to the nickel silicide (Ni₃₁Si₁₂). Thus, in Example 3, the TCR of the resistive element 13 is −0.5 ppm and is thus included within the predetermined range (see point P4 in FIG. 2). Note that in Example 3, the average resistance value of the chip resistor 1 is 363 mΩ. Moreover, in Example 3, as shown in Table 3, the copper-nickel alloy, the aluminum oxide, the nickel silicide, and the nickel aluminum boride are included in the resistive element 13.

Here, an approximation formula of the points P2 to P4 respectively corresponding to Examples 1 to 3 described above is formula (1) (see broken line a1 in FIG. 2). Note that “x” in formula (1) is a proportion of the glass particles B relative to the total of the glass particles A and B, and “y” in formula (1) is the TCR.

$$\begin{matrix}[ Formula 1 ] & \\ y = - 102.52 {x}^{2} + 228.81 x - 126.8 & ( 1 )\end{matrix}$$

When both the glass particles A and B are included in the resistive paste as Examples 1 and 2 described above, forming the resistive element 13 of the chip resistor 1 from the resistive paste produces nickel silicide (nickel silicide). Moreover, when only the glass particles B are included in the resistive paste as Example 3 described above, forming the resistive element 13 of the chip resistor 1 from the resistive paste produces nickel aluminum boride in addition to nickel silicide.

### (Aspects)

The present specification discloses the following aspects.

A resistive paste of a first aspect includes metal particles, insulating particles, glass particles, and a metal silicide. The metal particles include copper and nickel. The insulating particles include at least one of alumina, zirconia, zinc oxide, or boron nitride.

This aspect enables both high specific resistance and low TCR of a resistive element (13) to be achieved.

A resistive paste of a second aspect referring the first aspect includes, as the metal silicide, at least one of titanium silicide, zirconium silicide, hafnium silicide, niobium silicide, tantalum silicide, chromium silicide, tungsten silicide, molybdenum silicide, iron silicide, magnesium silicide, sodium silicide, or platinum silicide.

This aspect enables the TCR of the resistive element (13) to be suppressed from decreasing.

A resistive paste of a third aspect includes metal particles, insulating particles, a metal silicide, and glass particles. The metal particles include copper and nickel. The insulating particles include at least one of alumina, zirconia, zinc oxide, or boron nitride. The glass particles include at least boric oxide and aluminum oxide. A nickel compound including nickel silicide is produced from the resistive paste when a resistive element (13) of a chip resistor (1) is formed from the resistive paste.

This aspect enables both high specific resistance and low TCR of a resistive element (13) to be achieved.

In a resistive paste of a fourth aspect referring to the third aspect, the nickel compound further includes nickel aluminum boride.

This aspect enables the TCR of the resistive element (13) to be further reduced.

In a resistive paste of a fifth aspect referring to the fourth aspect, the nickel silicide is Ni₃₁Si₁₂, and the nickel aluminum boride is Ni₂₀Al₃B₆.

This aspect enables the TCR of the resistive element (13) to be further reduced.

In a resistive paste of a sixth aspect referring to any one of the third to fifth aspects, the glass particles further include silicium oxide, tantalum oxide, magnesium oxide, calcium oxide, and barium oxide.

This aspect enables reactiveness to the metal particles and the metal silicide to be further improved.

In a resistive paste of a seventh aspect referring to the sixth aspect, in the glass particles, the proportion of the boric oxide is greater than or equal to 41 wt % and less than or equal to 50 wt %, the proportion of the aluminum oxide is greater than or equal to 4 wt % and less than or equal to 9 wt %, the proportion of the silicium oxide is greater than or equal to 2 wt % and less than or equal to 7 wt %, the proportion of the tantalum oxide is greater than or equal to 3 wt % and less than or equal to 10 wt %, the proportion of the magnesium oxide is greater than or equal to 1 wt % and less than or equal to 5 wt %, the proportion of the calcium oxide is greater than or equal to 1 wt % and less than or equal to 5 wt %, and the proportion of the barium oxide is greater than or equal to 30 wt % and less than or equal to 35 wt %.

This aspect enables the nickel silicide to be produced.

In a resistive paste of an eighth aspect referring to any one of the third to seventh aspects, the metal silicide includes titanium silicide.

This aspect enables the nickel silicide to be produced.

A resistive paste of a ninth aspect referring to any one of the first to eighth aspects further includes an organic vehicle.

This aspect enables the materials to be mixed with each other and dispersed uniformly.

A chip resistor (1) of a tenth aspect includes a resistive element (13) and a substrate (11). The resistive element (13) includes the resistive paste of any one of the first to ninth aspects as a material and is disposed on the substrate (11).

This aspect enables both high specific resistance and low TCR of a resistive element (13) to be achieved.

In a chip resistor (1) of an eleventh aspect referring to the tenth aspect, the resistive element (13) includes nickel silicide.

This aspect enables the TCR of the resistive element (13) to be suppressed from decreasing.

Glass particles of a twelfth aspect are to be included in the resistive paste of any one of the third to ninth aspects.

This aspect enables both high specific resistance and low TCR of a resistive element (13) to be achieved.

The configurations of the second aspect and the fourth to ninth aspects are not essential configurations for the resistive paste and are thus accordingly omittable.

### REFERENCE SIGNS LIST

1 Chip Resistor

11 Substrate

13 Resistive Element

1. A resistive paste comprising:
metal particles including copper and nickel;
insulating particles including at least one of alumina, zirconia, zinc oxide, or boron nitride;
glass particles; and
a metal silicide.

2. The resistive paste of claim 1, comprising, as the metal silicide, at least one of titanium silicide, zirconium silicide, hafnium silicide, niobium silicide, tantalum silicide, chromium silicide, tungsten silicide, molybdenum silicide, iron silicide, magnesium silicide, sodium silicide, or platinum silicide.

3. A resistive paste comprising:
metal particles including copper and nickel;
insulating particles including at least one of alumina, zirconia, zinc oxide, or boron nitride;
a metal silicide; and
glass particles,
the glass particles including at least boric oxide and aluminum oxide,
a nickel compound including nickel silicide being produced from the resistive paste when a resistive element of a chip resistor is formed from the resistive paste.

4. The resistive paste of claim 3, wherein
the nickel compound further includes nickel aluminum boride.

5. The resistive paste of claim 4, wherein
the nickel silicide is Ni₃₁Si₁₂, and
the nickel aluminum boride is Ni₂₀Al₃B₆.

6. The resistive paste of claim 3, wherein
the glass particles further include silicium oxide, tantalum oxide, magnesium oxide, calcium oxide, and barium oxide.

7. The resistive paste of claim 6, wherein
in the glass particles, a proportion of the boric oxide is greater than or equal to 41 wt % and less than or equal to 50 wt %, a proportion of the aluminum oxide is greater than or equal to 4 wt % and less than or equal to 9 wt %, a proportion of the silicium oxide is greater than or equal to 2 wt % and less than or equal to 7 wt %, a proportion of the tantalum oxide is greater than or equal to 3 wt % and less than or equal to 10 wt %, a proportion of the magnesium oxide is greater than or equal to 1 wt % and less than or equal to 5 wt %, a proportion of the calcium oxide is greater than or equal to 1 wt % and less than or equal to 5 wt %, and a proportion of the barium oxide is greater than or equal to 30 wt % and less than or equal to 35 wt %.

8. The resistive paste of claim 3, wherein the metal silicide includes titanium silicide.

9. The resistive paste of claim 1, further comprising an organic vehicle.

10. A chip resistor comprising:
a substrate; and
a resistive element on the substrate, the resistive element including the resistive paste of claim 1 as a material.

11. The chip resistor of claim 10, wherein
the resistive element includes nickel silicide.

12. Glass particles to be included in the resistive paste of claim 3.

13. A chip resistor comprising:
a substrate; and
a resistive element on the substrate, the resistive element including the resistive paste of claim 3 as a material.

14. The chip resistor of claim 13, wherein
the resistive element includes nickel silicide.
